(19) United States
(12) Patent Application Publication
(10) Pub. No.: US 2002/0118932 A1
(43) Pub. Date: Aug. 29, 2002

(54) Method of installing cables and cable for installation in a drinking water pipe

(75) Inventors: Klaus Nothofer, Erdrath (DE); Hans-Detlef Leppert, Monchengladbach (DE); Hans-Jurgen Lysson, Korschenbroich (DE); Wolfgang Teschner, Wunstorf (DE)

Correspondence Address: SUGHRUE MION, PLLC, 2100 Pennsylvania Avenue, N.W., Washington, DC, 20037-3213, US

(73) Assignee: ALCATEL

(21) Appl. No.: 10/079,879

(22) Filed: Feb. 22, 2002

(30) Foreign Application Priority Data
Feb. 24, 2001 (DE) 101 09 114.1

(51) Int. Cl. G02B 6/44; B05D 5/06; B29D 11/00

(52) U.S. Cl. 385/100; 427/163.2; 264/1.28

(57) ABSTRACT

The invention relates to a method of installing cables, in particular glass-fiber cables, in drinking water pipes and also to a cable suitable for drinking water pipe installation. In order to avoid contamination of the cable and to exclude contamination of the drinking water, provision is made that the cable is covered with a protective sheathing that is stripped off prior to contact with the drinking water. A cable suitable for this purpose can be covered already during its production process with the strippable protective sheathing.

### BACKGROUND OF THE INVENTION

The invention is based on a priority application DE 101 09 114.1 which is hereby incorporated by reference. The invention relates to a method of installing cables, in particular glass-fibre cables, in drinking water pipes and to a cable for installation in a drinking water pipe.

To lay cables of all types, all the possibilities have to be utilized, in particular if recourse can be made to already existing channels or pipelines. Drinking water pipes are also suitable in principle for cable installation. For hygienic and health reasons, however, strict attention must be paid in this case to ensuring that the cable to be laid meets very high sterility requirements. Any contaminants on the cable surface that may be due to the production process, storage or installation within the water pipe are unacceptable. An installation permit issued by the water works requires the reliable maintenance of appropriate hygiene standards. Cleaning the cable immediately prior to contact with the drinking water does not always satisfy these requirements. Only specific contaminants can be removed by the type of cleaning operation. It is, however, important to remove both dust and grease residues, and, for example, oil contaminants, paint contaminants or other contaminants engendered by the installation.

### SUMMARY OF THE INVENTION

The object of the invention is to provide a method of the generic kind that is distinguished by its reliable cleaning effect for any type of contamination.

The basic idea is to provide a cable with a protective sheathing that is stripped off prior to contact with the drinking water. The temporary protective sheathing yields a reliable cleaning effect in a simple way. At the same time, the nature of the contaminant does not play a part. Precautionary measures to prevent the contamination of the cable can ultimately be dispensed with because of the covering. The cable is preferably already covered with the removable protective sheathing during its production, thereby guaranteeing protection also during storage, transport or other intermediate steps right up to the installation operation installation in the water pipe. The adhesive action between the cable surface and the protective sheathing should make possible a closely fitting covering, but be weak in that adhesion and, consequently, poor removal capability are avoided.

In an advantageous further development, an extrusion method is used to shrink a thin, film-like plastic skin onto the cable. This yields a closely fitting covering that does not adhere to the cable surface.

It is also possible, in yet a further development, to lay a narrow-strip plastic skin around the cable in the longitudinal direction, a slight overlapping of the longitudinal sides being provided.

In order to facilitate the removal of the protective sheathing, the protective sheathing is provided, in yet a further development, with tear-off aids. These could be formed by overlapping areas of individual covering sections or by tear-off straps. In the case of hose-type coverings, overlapping areas can be provided at the hose openings. In the case of coverings carried out by login a strip-type plastic skin in an overlapping way longitudinally around the cable the overlaps already present and extending in the cable longitudinal direction can be used for this purpose.

A cable, in particular a glass-fibre cable according to the invention, that is provided for installation in a drinking water pipe is fitted with a removable protective sheathing. Said protective sheathing is preferably already taken into account within the scope of the production method of the cable.

1. A method of installing cables, in particular glass-fibre cables, in drinking water pipes, wherein the cable is covered with a protective sheathing that is stripped off prior to contact with the drinking water.

2. A method according to claim 1, wherein the covering is carried out by extruding a plastic skin onto the cable surface.

3. A method according to claim 1, wherein the covering is carried out by laying a strip-type plastic skin in a mutually overlapping way longitudinally around the cable.

4. A method according to claim 1, wherein the protective sheathing is provided with tear-off aids.

5. A cable, in particular a glass-fibre cable, for installation in a drinking water pipe, that is covered a strippable protective sheathing.
